(19) United States
(12) Patent Application Publication
(10) Pub. No.: US 2012/0027447 A1
(43) Pub. Date: Feb. 2, 2012

(54) HIGH-VOLTAGE GENERATION APPARATUS AND IMAGE FORMING APPARATUS

(75) Inventor: Takuya Mukaibara, Susono-shi (JP)

(73) Assignee: CANON KABUSHIKI KAISHA, Tokyo (JP)

(21) Appl. No.: 13/189,073

(22) Filed: Jul. 22, 2011

(30) Foreign Application Priority Data
Jul. 30, 2010 (JP) 2010-172292

(51) Int. Cl. G03G 15/00; H02M 3/335

(52) U.S. Cl. 399/88; 363/21.01

(57) ABSTRACT

A high-voltage generation apparatus raises, in a transient-state period elapsed since output of a voltage is started until the voltage reaches a target value, the output voltage by a change amount corresponding to the target value without performing feedback control.

### BACKGROUND OF THE INVENTION

1. Field of the Invention

The present invention relates to a high-voltage generation apparatus, and more particularly, to a high-voltage generation apparatus capable of raising the high voltage to a target voltage at high speed, and an image forming apparatus including the high-voltage generation apparatus.

2. Description of the Related Art

In a conventional electrophotographic image forming apparatus, a charging device uniformly charges a surface of an electrophotographic photosensitive member (hereinafter referred to as a photosensitive drum), and an exposure device exposes the charged surface of the photosensitive drum, to form an electrostatic latent image. A development device develops the electrostatic latent image with a developer (hereinafter referred to as toner), to form a toner image, and a transfer device transfers the developed toner image onto a recording material. A fixing device fixes the toner image onto the recording material, and outputs the fixed toner image. The transfer device includes a transfer roller for forming a nip portion with the photosensitive drum and conveying the recording material. A high voltage that is opposite in polarity to the toner (hereinafter referred to as a transfer bias) is applied so that the toner image is transferred onto the recording material.

Control to apply the transfer bias will be described below. A resistance of the transfer roller to which the transfer bias is applied easily varies according to ambient temperature and humidity. When an applied current value is lower than a desired transfer current value, defective transfer may occur. When the applied current value is higher than the desired transfer current value, an excessive current flows in a margin portion of the recording material (an area where the toner image has not been formed), and the effect of the excessive current also remains after the recording material goes around the photosensitive drum so that a trace of the recording material appears on the photosensitive drum. When a recording material of a small size passes through the transfer roller, a large part of the excessive transfer current flows between the transfer roller, which is not covered with the recording material, and the photosensitive drum so that image defect called a ghost may occur. In order to optimize the transfer bias to be applied to the transfer roller so that the excessive transfer current is not applied, a resistance value of the transfer roller is measured, and the transfer bias is properly controlled according to a measurement result. This control is a well-known control method called active transfer voltage control (ATVC).

In the ATVC control, the transfer bias is applied to the transfer roller while the photosensitive drum is rotated for a predetermined period prior to an image forming process after a printing instruction, an applied current value at this time is measured, and the measured value is fed back to a controller. The controller adjusts the transfer bias so that the applied current value becomes a predetermined value. The adjusted transfer bias is applied to the transfer roller during transfer in the image forming process. According to this ATVC control, even if an impedance of the transfer roller varies with a change in environment, the transfer bias can be applied so that the applied current value becomes an appropriate value.

Recently, a method for performing the ATVC control by software in a controller instead of performing the control by hardware has been mainstream. This is an effective method for achieving simplification and stabilization of a circuit configuration and control. More specifically, processing for applying a transfer bias to a transfer roller as a predetermined voltage, monitoring an applied current value detected by hardware at this time using a controller, and finding a transfer bias (a voltage value) to be applied from the monitored current value and a target current value are executed by software. If an output range of the transfer bias and a range of a load variation are wide, however, the following issue arises when the above-mentioned control method by software is executed.

When a characteristic of an applied bias at the time of startup greatly differs depending on a load condition (e.g., a load variation), for example, a startup time elapsed until the bias converges at a target voltage may vary, and an overshoot or an undershoot may occur. This may cause a decrease in image quality or a deterioration of the photosensitive drum.

Japanese Patent Application Laid-Open No. 2004-88965 discusses an image forming apparatus in which a controller compares an output value obtained by analog-to-digital (A/D) conversion and a target voltage for each predetermined period (e.g., every 10 ms), and controls a pulse width modulation (PWM) signal for driving a boosting transformer according to a comparison result, to reduce a variation in a startup time and an overshoot or an undershoot.

Japanese Patent Application Laid-Open No. 2004-88965 discusses a method for calculating an average of impedances from an output value obtained by performing A/D conversion a plurality of numbers of times from a leading edge of a recording material and an output voltage that has been fed back, and calculating a value of a PWM signal (i.e., a time width of a high-level pulse out of high-level and low-level pulses of the PWM signal, which is hereafter referred to as an on-duty or an on-duty width) based on two conditions, i.e., a range of the calculated average (a first condition) and a range of a difference between the current output value and a target voltage (a second condition). According to Japanese Patent Application Laid-Open No. 2004-88965, control by software enables a time required for the output voltage to converge toward a desired transfer bias to be shortened, and enables an overshoot or an undershoot to be reduced.

As another example for raising a high voltage to a target voltage at high speed, Japanese Patent Application Laid-Open No. 9-93920 discusses a method for comparing a detected voltage of a voltage detection circuit and a second reference voltage slightly lower than a reference voltage, to perform control to slow a charging rate to a capacitor serving as a load when the detected voltage of the voltage detection circuit exceeds the second reference voltage. In Japanese Patent Application Laid-Open No. 9-93920, a fast charging area, a slow charging area, and a maintenance charging area are provided in this order from the time of startup. After the start of the startup, an output voltage is rapidly raised by setting an on-duty width of a PWM signal to the maximum on-duty width. When the output voltage becomes the second reference voltage (exemplified as approximately 90%), the fast charging area is switched to the slow charging area. An integration circuit is provided on the input side of a circuit for generating a pulse of the PWM signal. The capacitor is rapidly charged in an early stage of a startup time by the integration circuit, while being slightly charged and discharged in the slow charging area and the maintenance charging area so that an overshoot or an undershoot is suppressed.

As described above, there have been devices to increase the speed of control of a transfer bias and reduce an overshoot or an undershoot. Recently, as one of measures to improve the productivity of an image forming apparatus, a time elapsed since a computer such as a personal computer (PC) issued a printing instruction (sent a print command) until printing on a first recording material is completed (hereinafter referred to as a first print out time (FPOT)) is required to be further shortened. When the FPOT is further shortened, a user can enjoy an advantage that printing is completed in a short time after the printing instruction is issued. When the FPOT is further shortened, a time required to perform the above-mentioned ATVC control is required to be further shortened.

The control method for the control voltage to converge at the target voltage by software, which is discussed in Japanese Patent Application Laid-Open No. 2004-88965, also produces a time shortening effect to some extent. However, a setting update by the software is executed at predetermined intervals so that a control period is lengthened. Further, a convergence time corresponding to the cumulative number of updates is required. Therefore, the control by the software has a limitation for the output voltage to further converge at the target voltage in a short time.

In the control method discussed in Japanese Patent Application Laid-Open No. 2004-88965, the output voltage converges at the target voltage in open-loop control by changing the on-duty width of the PWM signal for switching the boosting transformer. An output value is not detected until hardware is started up (reaches a steady area), to update the succeeding set value. More specifically, if the on-duty width and the output voltage (the reach voltage in the steady area without feedback control) have a relationship of linearity, the speed of the control method can be increased. However, a circuit having linearity is not easily configured, and the linearity is not easily retained because it is affected by a time constant of a circuit and a variation in each element. If the linearity is not retained, a change amount of the output voltage varies even if it has the same time width, so that stability and accuracy of control of the output voltage are reduced. An attempt to improve the linearity may conversely raise the possibility that another adverse effect such as a decrease in response occurs.

In Japanese Patent Application Laid-Open No. 9-93920, in the maintenance charging area where control for maintaining a target voltage is performed, control to slightly increase or decrease an output voltage to maintain the output voltage at the target voltage is performed by slightly increasing or decreasing an input voltage for a circuit for outputting the pulses of the PWM signal. However, the input voltage is only slightly decreased at the time of transition from the slow charging area to the maintenance charging area. Therefore, an overshoot voltage is not easily reduced. In order to reduce the overshoot voltage, startup in the slow charging area may be made slower. However, if the startup is made too slow, a startup time is lengthened. The integration circuit is used on the input side of the circuit for outputting the pulse of the PWM signal. If the integration circuit is used, a start time (an integration time) to raise the on-duty width of the PWM signal from zero to the maximum on-duty width is required.

### SUMMARY OF THE INVENTION

According to an aspect of the present invention, a high-voltage generation apparatus includes a transformer, a switching unit configured to drive the transformer, a generation unit configured to generate a driving signal for driving the switching unit, a rectification unit configured to rectify an output voltage from the transformer to output a direct-current voltage, a detection unit configured to detect the direct-current voltage, a setting unit configured to set a target voltage of the direct-current voltage, a feedback control unit configured to control the driving signal according to the detected direct-current voltage and the set target voltage, and an output control unit configured to raise the direct-current voltage by a change amount corresponding to the target voltage without performing a feedback control by the feedback control unit in a transient-state period elapsed since the output of the direct-current voltage is started until the direct-current voltage reaches the target voltage.

According to another aspect of the present invention, an image forming apparatus includes an image forming unit configured to form an image on a recording material, and a high-voltage power source configured to apply a high voltage to the image forming unit, in which the high-voltage power source includes a transformer, a switching unit configured to drive the transformer, a generation unit configured to generate a driving signal for driving the switching unit, a rectification unit configured to rectify an output voltage from the transformer to output a direct-current voltage, a detection unit configured to detect the direct-current voltage, a setting unit configured to set a target voltage of the direct-current voltage, a feedback control unit configured to control the driving signal according to the detected direct-current voltage and the set target voltage, and an output control unit configured to raise the direct-current voltage by a change amount corresponding to the target voltage without performing a feedback control by the feedback control unit in a transient-state period elapsed since the output of the direct-current voltage is started until the direct-current voltage reaches the target voltage.

According to yet another aspect of the present invention, a high-voltage generation apparatus includes an output unit configured to output a voltage, a detection unit configured to detect the output voltage, a setting unit configured to set a target value of the output voltage, a feedback control unit configured to control driving of the voltage output unit according to the detected voltage and the set target value, and an output control unit configured to control to raise the output voltage by a change amount corresponding to the target value without performing the control by the feedback control unit in a transient-state period elapsed since the output of the voltage from the voltage output unit is started until the voltage reaches the target value.

According to yet another aspect of the present invention, an image forming apparatus includes an image forming unit configured to form an image on a recording material, and a high-voltage power source configured to apply a high voltage to the image forming unit, in which the high-voltage power source includes an output unit configured to output a voltage, a detection unit configured to detect the output voltage, a setting unit configured to set a target value of the output voltage, a feedback control unit configured to control driving of the voltage output unit according to the detected voltage and the set target value, and an output control unit configured to control to raise the output voltage by a change amount corresponding to the target value without performing the control by the feedback control unit in a transient-state period elapsed since the output of the voltage from the voltage output unit is started until the voltage reaches the target value.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a voltage waveform generated when an output voltage of a high-voltage generation apparatus reaches a target voltage in a transient state.

FIGS. 2A to 2C are functional block diagrams respectively illustrating a conventional high-voltage generation apparatus, a high-voltage generation apparatus according to a first exemplary embodiment of the present invention, and a high-voltage generation apparatus according to a second exemplary embodiment of the present invention.

FIG. 3 illustrates a circuit configuration of the high-voltage generation apparatus according to the first exemplary embodiment.

FIGS. 4A to 4C illustrate examples of an output waveform of the high-voltage generation apparatus at a target voltage of +5 kV.

FIGS. 5A to 5C illustrate examples of an output waveform of the high-voltage generation apparatus at a target voltage of +1 kV.

FIGS. 6A to 6D illustrate examples of an output waveform of the high-voltage generation apparatus with the vicinity of a target voltage enlarged.

FIGS. 7A and 7B illustrate examples of an output waveform of the high-voltage generation apparatus according to the first exemplary embodiment.

FIG. 8 illustrates a relationship between a target voltage and a timer time according to the first exemplary embodiment.

FIG. 9 illustrates a circuit configuration of the high-voltage generation apparatus according to the second exemplary embodiment.

FIG. 10 illustrates a circuit configuration of the high-voltage generation apparatus according to a third exemplary embodiment of the present invention.

FIGS. 11A to 11C illustrate examples of output waveforms of the high-voltage generation apparatuses according to the second and third exemplary embodiments.

FIGS. 12A and 12B illustrate a relationship between an on-duty width of a PWM signal and a high output voltage.

FIGS. 13A and 13B illustrate a relationship between a power source voltage to be supplied to a boosting transformer and a high output voltage.

FIG. 14 illustrates a relationship between an on-duty width of a PWM signal and a high output voltage after a lapse of a predetermined time.

FIGS. 15A and 15B illustrate examples of an application of a high-voltage generation apparatus according to an exemplary embodiment of the present invention.

### DESCRIPTION OF THE EMBODIMENTS

Various exemplary embodiments, features, and aspects of the invention will be described in detail below with reference to the drawings.

A high-voltage generation apparatus according to an exemplary embodiment of the present invention shortens a startup time by hardware and further shortens a time for one updating cycle to shorten a convergence time at a target voltage. More specifically, in a stage before startup of the high-voltage generation apparatus, in a transient-state period of the startup or a period that is at least a part of the startup, a slew rate or a startup period width is variably set according to the magnitude of a target voltage. Further, a boosting transformer in the high-voltage generation apparatus starts to be driven under a driving condition in which an output voltage reaches a target voltage at a steep slew rate in a transient state. The output voltage can converge at the target voltage without any overshoot or undershoot and in a short time regardless of whether the target voltage is high or low.

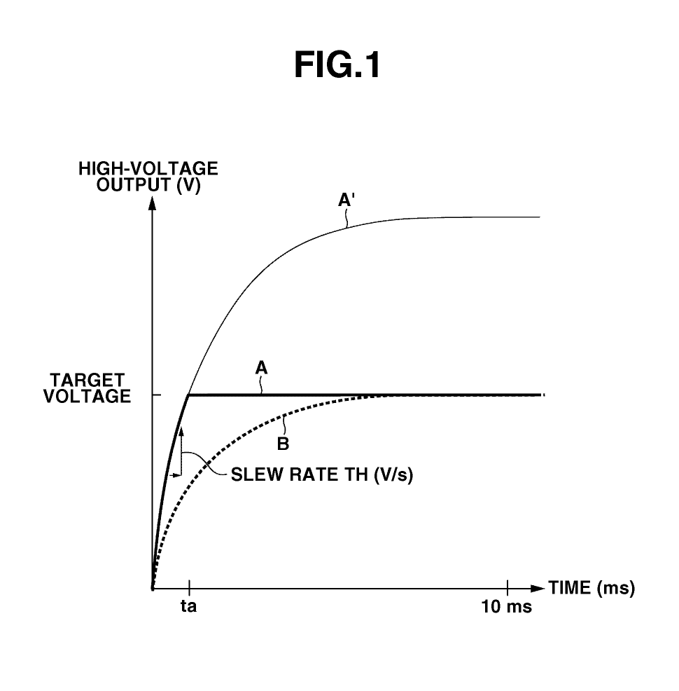

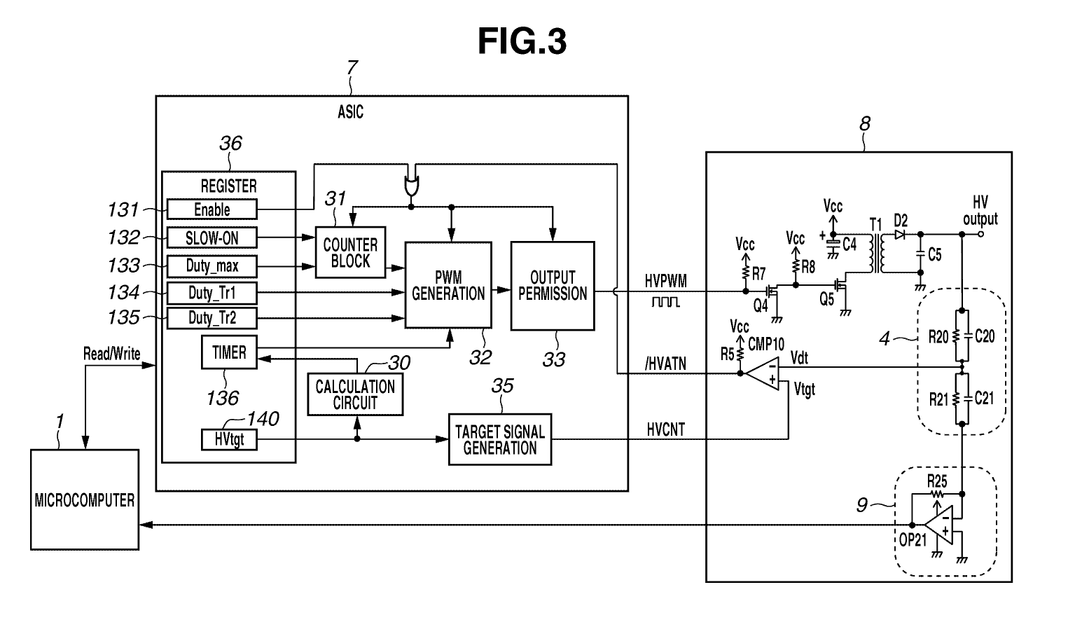

FIG. 1 is a schematic view of an output waveform during an operation of a high-voltage generation apparatus in which an output voltage reaches a target voltage at a steep slew rate. An output waveform B illustrated in FIG. 1 is an example of a waveform generated when an output voltage in a high-voltage generation circuit 8 (FIG. 3) rises toward a target voltage according to a curve of a predetermined time constant. An output waveform A′ is generated when the boosting transformer is driven under a driving condition in which the output voltage reaches the target voltage or more, and a time constant is the same as that in the output waveform B. On the other hand, a time to elapsed until the output voltage reaches the same target voltage for the waveform A′ becomes significantly shorter than that for the waveform B. In the high-voltage generation apparatus, the output voltage is raised to the target voltage or the vicinity of the target voltage using a steep slew rate portion TH in the transient state, and a high-speed constant voltage control circuit (hardware) then performs high-speed feedback control for maintaining the target voltage. The slew rate is a voltage change amount (V/s) per unit time.

A high-voltage generation apparatus according to a first exemplary embodiment of the present invention divides a transient-state period elapsed from the start of startup until an output voltage reaches a target voltage into a high-speed startup period immediately after the start of startup and a constant voltage control waiting period elapsed before the output voltage reaches the target voltage, and respectively sets on-duty widths (conduction time widths) of PWM signals serving as driving signals for switching between the high-speed startup period and the constant voltage control waiting period. In the constant voltage control waiting period elapsed before the output voltage reaches the target voltage, control is performed so that the on-duty width is decreased, and a startup capability of the high-voltage generation apparatus (hereinafter described as a capability representing the magnitude of a voltage for raising a potential at a load output unit per unit time) is reduced. The high-speed startup period in the transient-state period can be previously variably set according to the magnitude of the target voltage.

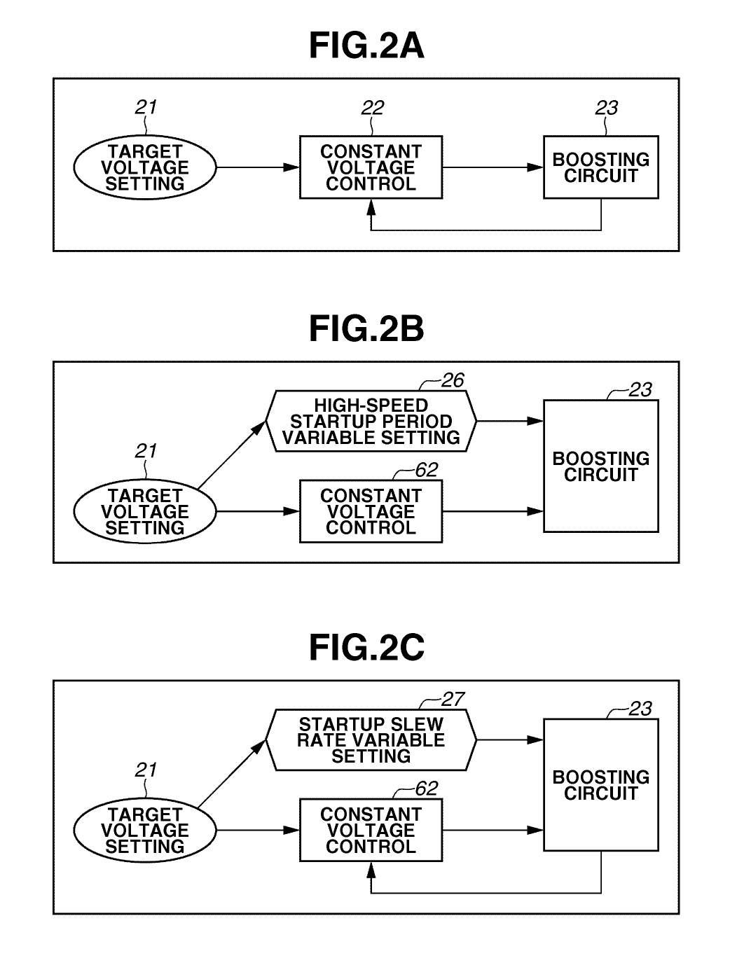

FIG. 2B is a block diagram schematically illustrating a function of the high-voltage generation apparatus according to the present exemplary embodiment. FIG. 2A is a block diagram schematically illustrating a conventional high-voltage generation apparatus. In the conventional high-voltage generation apparatus illustrated in FIG. 2A, a constant voltage control block 22 monitors an output unit in a boosting circuit unit 23 so that an output set by a target voltage setting unit 21 is obtained while performing feedback control of an input unit. The high-voltage generation apparatus according to the present exemplary embodiment includes a block 26 capable of variably setting a high-speed startup period T1.

The outline of a configuration of the high-voltage generation apparatus will be first described with reference to FIG. 3. The high-voltage generation apparatus illustrated in FIG. 3 includes a high-voltage generation circuit 8 composed of an analog circuit, and an application specific integrated circuit (ASIC) 7 serving as an output control unit for generating a hardware control signal to be output to the high-voltage generation circuit 8 to control an output from the high-voltage generation circuit 8. The high-voltage generation apparatus further includes a microcomputer 1 for controlling and setting an output state of the hardware control signal generated by the ASIC 7. Further, the high-voltage generation circuit 8 composed of an analog circuit includes a boosting transformer T1, a boosting circuit, an output voltage detection circuit 4, a comparator CMP10, and an output current detection circuit 9.

The microcomputer 1 sets data at predetermined timing for a register 36 provided in the ASIC 7 to set a target voltage in the high-voltage generation apparatus, set ON/OFF timing, an on-duty width of a PWM signal, and set a timer time, described below. The ASIC 7 outputs a high-voltage control signal HVCNT for setting a target voltage of the high-voltage generation circuit 8 and a PWM signal HVPWM for performing switching driving of the high-voltage generation circuit 8 to the exterior, and receives a target voltage reach signal/HVATN indicating that an output voltage of the high-voltage generation circuit 8 has reached the target voltage from the exterior.

The high-voltage control signal HVCNT is output to the exterior as an analog signal from a digital-to-analog (D/A) converter provided in the ASIC 7. The high-voltage control signal HVCNT may be output in the form of a PWM signal, or may be converted into a direct-current (DC) voltage by a high-order low-pass filter or the like having an improved response characteristic at a frequency of the PWM signal.

The output current detection circuit 9 virtually grounds one end of the output voltage detection circuit 4 to hold a ground (GND) potential, to prevent a reduction in detection accuracy of the output voltage depending on the magnitude of a load current while detecting the load current with high accuracy. The output current detection circuit 9 detects the load current for the above-mentioned ATVC control.

An outline of an operation of the high-voltage generation circuit 8 in the high-voltage generation apparatus illustrated in FIG. 3 will be described below. The boosting transformer T1 is switching-driven in response to the PWM signal output from the ASIC 7. The output voltage detection circuit 4 divides a high voltage output from the boosting transformer T1 to detect a divided voltage Vdt, and the comparator CMP10 performs comparison calculation of the detected divided voltage Vdt with a target voltage Vtgt set by the high-voltage control signal HVCNT. Feedback control of the on-duty width of the PWM signal output by the ASIC 7 is performed according to a comparison calculation result.

A configuration of a hardware logic circuit loaded in the ASIC 7 will be described below. Setting units in the register 36 will be first described. The register 36 includes the following setting units:
an Enable setting unit 131 for permitting or stopping an output of the PWM signal
a slow-on setting unit 132 for setting a time width for gradually increasing the on-duty width of the PWM signal
a DUTY_max setting unit 133 for setting the maximum on-duty width of the PWM signal
a DUTY_Tr1 setting unit 134 for setting the on-duty width used in a high-speed startup period T1
a DUTY_Tr2 setting unit 135 for setting the on-duty width used in a constant voltage control waiting period T2
a timer setting unit 136 for setting a time interval between outputs of the PWM signal
an HVtgt setting unit 140 for setting the target voltage of the high-voltage generation circuit 8

Circuits other than the register 36 provided in the ASIC 7 will be described below. A calculation circuit 30 calculates a timer time uniquely determined according to a set register value in the HVtgt setting unit 140. A counter block 31 functions to gradually increase the on-duty width from zero to the maximum on-duty width set in the DUTY_max setting unit 133 by the time width set in the slow-on setting unit 132 and output the maximum on-duty width from a PWM generation unit 32. The microcomputer 1 can variably set the maximum on-duty width for the DUTY_max setting unit 133. A startup capability of the high-voltage generation apparatus is easily adjustable without changing hardware (specifications such as the number of windings of the boosting transformer T1).

The PWM generation unit 32 outputs a PWM signal having the on-duty width set in the DUTY_Tr1 setting unit 134 at the time interval set in the timer setting unit 136 and at switching timing corresponding to setting by the Enable setting unit 131. The output of the PWM signal is followed by output of a PWM signal having the on-duty width set in the DUTY_Tr2 setting unit 135. The on-duty width of the PWM signal is instantaneously reduced to zero when the signal /HVATN indicating that the output voltage reaches the target voltage enters a low level. Then, the PWM generation unit 32 is controlled to output a PWM signal having an on-duty width that gradually increases. An output permission unit 33 stops outputting the PWM signal when either one of the Enable setting unit 131 and the target voltage reach signal/HVATN enters a low level. A target signal generation unit 35 generates an analog signal based on the set register value in the HVtgt setting unit 140.

The following are six functions (a) to (f) of the hardware logic circuit in the ASIC 7 described above:

(a) A register for setting a plurality of on-duty widths set by the microcomputer 1, a register for enabling output of a PWM signal, a register for setting a target voltage, and a register for setting a time width for gradually increasing an on-duty width of a PWM signal. The register for setting a plurality of on-duty widths includes a register for setting an on-duty width of a PWM signal in the high-speed startup period T1, a register for setting an on-duty width of a PWM signal in the constant voltage control waiting period T2, and a register for setting the maximum time width of a PWM signal that can be generated in a constant voltage control area.

(b) An analog signal that has followed a value of the register for setting a target voltage (the HVtgt setting unit 140) is output to the outside of the ASIC 7 via the D/A converter.

(c) A timer time based on the value of the register for setting a target voltage (the HVtgt setting unit 140) is calculated and written into the register.

(d) The PWM signal having the on-duty width in a high-speed startup period T1 and the PWM signal having the on-duty width in a constant voltage control waiting period T2 are sequentially generated and output according to the timer time.

(e) The on-duty width of the PWM signal is instantaneously reduced to zero by a target voltage reach signal (/HVATN) input from the exterior.

(f) The on-duty width is gradually increased from zero to a predetermined on-duty width by the time width set in the register.

Details of the generation of the PWM signal and the setting of the timer time respectively described in the foregoing items (c) and (d) will be described with reference to FIG. 3.

The calculation circuit 30 sets the timer time uniquely determined according to the set register value in the HVtgt setting unit 140 in the timer setting unit 136. The timer time to be set will be described below. The set register value in the HVtgt setting unit 140 and the timer time in the timer setting unit 136 are in a relative relationship of linearity. The microcomputer 1 sets the Enable register 131, to start to output a voltage. The PWM generation unit 32 outputs the PWM signal having the on-duty width that has followed the on-duty width in the high-speed startup period T1 set in the DUTY_Tr1 setting unit 134 in a time interval based on the timer time set in the timer setting unit 136. The PWM signal is output by the function of the ASIC 7. Therefore, a startup time for increasing the on-duty width from zero to the on-duty width of the PWM signal is not required. The PWM signal having the set on-duty width can be instantaneously output, starting at its first pulse. When the timer time set in the timer setting unit 136 has elapsed, a PWM signal having an on-duty width that has followed the DUTY_Tr2 setting unit 135 for setting the on-duty width in the constant voltage control waiting period T2 is then output.

More specifically, the PWM generation unit 32 outputs a PWM signal having a large on-duty width, starting at its first pulse, immediately after the startup of the high-voltage generation apparatus is started, to instantaneously raise an output voltage at a steep and high slew rate. The PWM generation unit 32 outputs a PWM signal having an on-duty width at a low slew rate so that an overshoot, an undershoot, or a voltage vibration does not occur after a previously set timer time has elapsed. The timer time is variably set to a value that is kept in a relationship of linearity with the target voltage. Therefore, the high-voltage generation apparatus can be started in a startup time width (at a slew rate) that has been varied depending on the target voltage. After a lapse of the timer time, the high-speed startup period T1 is switched to the constant voltage control waiting period T2. Therefore, even in a high-voltage generation apparatus a startup capability of which is set high, an on-duty width of a PWM signal first output is corrected according to the magnitude of a target voltage. Thus, when the target voltage is high, a switching time by a PWM signal having a large on-duty width is lengthened, to shorten a startup period. On the other hand, when the target voltage is low, the switching time is shortened, to reduce an overshoot or an undershoot. More specifically, the overshoot or the undershoot can be reduced regardless of whether the target voltage is high or low, and the output voltage can reach the target voltage in a short time.

Details of control of the on-duty width of the PWM signal in response to the target voltage reach signal/HVATN described in the above-mentioned items (e) and (f) will be described below. Peripheral circuits of the boosting transformer T1 provided in the high-voltage generation circuit 8 will be first described, and an operation of the comparator CMP10 that outputs the target voltage reach signal /HVATN will be then described.

The PWM signal HVPWM output from the ASIC 7 is input to a gate terminal of a field effect transistor (FET) Q4. The FET Q4, a power source voltage Vcc, and a resistor R8 drive a gate terminal of an FET Q5 (a power metal oxide semiconductor field effect transistor (power MOSFET) in this example) in response to the PWM signal HVPWM input to the gate terminal of the FET Q4. The FET Q5 switching-drives the boosting transformer T1. The boosting transformer T1, which has been switching-driven, outputs a high pulsating voltage. The high pulsating voltage output from the boosting transformer T1 is output to a load unit HVoutput after being rectified by a rectification circuit including a diode D2, a capacitor C5, and the output voltage detection circuit 4 and changed into a DC voltage. The output voltage detection circuit 4 divides the high output voltage to the load unit HVoutput, to detect a divided voltage Vdt. The comparator CMP10 monitors the detected divided voltage Vdt, and compares the divided voltage Vdt with a target voltage Vtgt set in response to the high-voltage control signal HVCNT. The comparator CMP10, which has compared the detected voltage Vdt and the target voltage Vtgt, generates a high-level output when the detected voltage Vdt is the target voltage Vtgt or less, and generates a low-level output when the detected voltage Vdt is the target voltage Vtgt or more.

The ASIC 7 instantaneously masks the PWM signal output by the output permission unit 33 when the target voltage reach signal /HVATN enters a low level, to instantaneously reduce the on-duty width of the PWM signal to zero. The on-duty width becomes a low-level logic in the PWM signal HVPWM output from the ASIC 7, and becomes a high-level logic at the gate terminal of the FET Q5. More specifically, a signal fixed at a high level is output. When the PWM signal instantaneously outputs the signal fixed at a high level, the FET Q4 is turned off, and the FET Q5 connected thereto is instantaneously turned off, to instantaneously turn off the high-voltage generation circuit 8.

On the other hand, when the target voltage reach signal /HVATN is changed from a low level to a high level, the counter block 31 outputs to the PWM generation unit 32 data for gradually increasing the on-duty width to the on-duty width based on data set in the DUTY_max setting unit 133. The time width for gradually increasing the on-duty width is determined by a register value in the slow-on setting unit 132. The PWM generation unit 32 outputs a slow-on PWM signal to the outside of the ASIC 7.

More specifically, the ASIC 7 instantaneously reduces the on-duty width of the PWM signal to zero when the detected voltage Vdt exceeds the target voltage Vtgt, to instantaneously turn off the high-voltage generation circuit 8. When the detected voltage Vdt falls below the target voltage Vtgt, a time constant is given to an increase in the on-duty width, to slowly turn on the high-voltage generation circuit 8. Thus, a voltage vibration (also referred to as a ripple or a hunting) generated by feedback control when the high-voltage generation circuit 8 is maintained at a constant voltage can be significantly reduced.

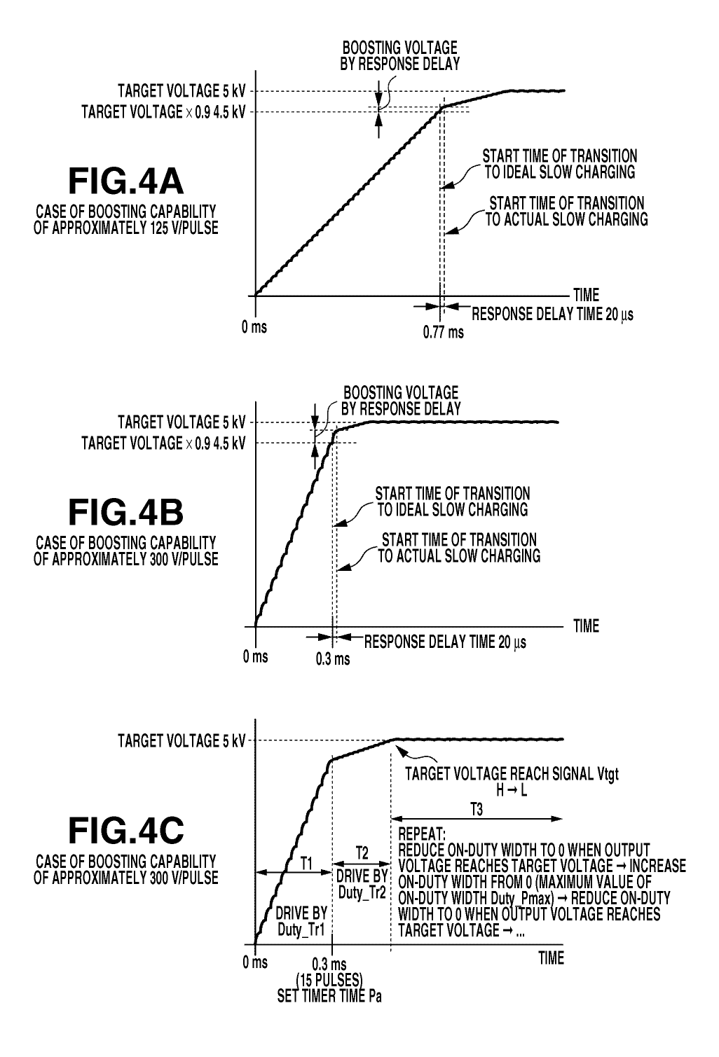

FIGS. 4A to 4C, FIGS. 5A to 5C, and FIGS. 6A to 6D illustrate specific examples of an output waveform generated by applying the functions of the high-voltage generation circuit 8 serving as an analog circuit and the ASIC 7 in the high-voltage generation apparatus, described above, as contrasted with an output waveform generated when the speed of the conventional high-voltage generation apparatus is increased.

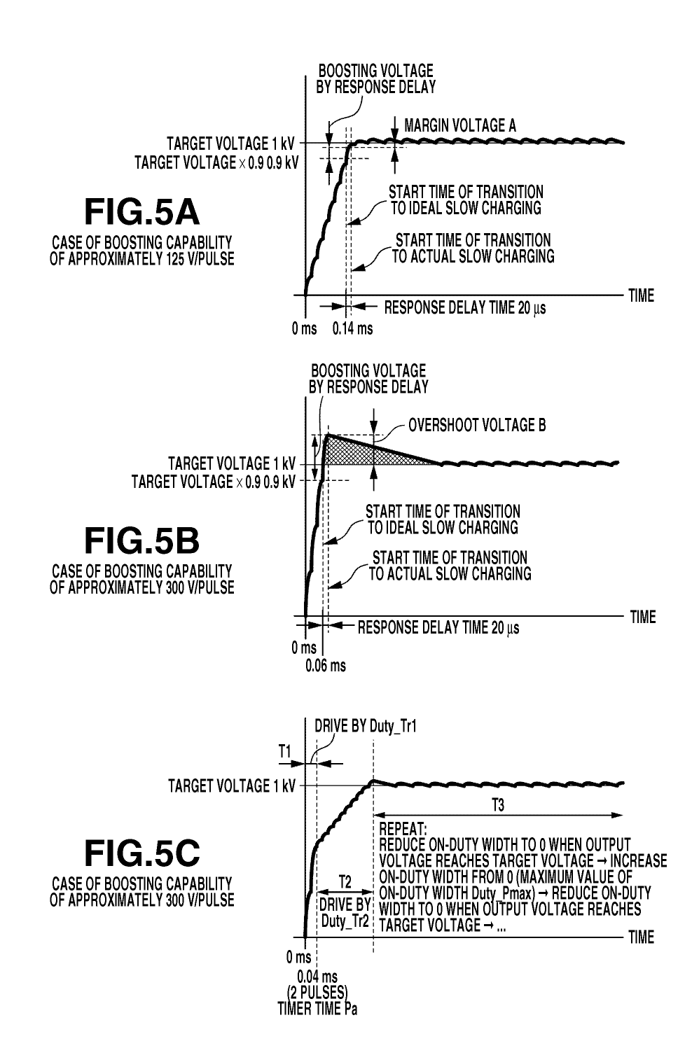

In the present exemplary embodiment, the present invention is applied to a high-voltage generation apparatus in which a driving frequency of the boosting transformer T1 is 50 kHz (a period of 20 μs) and an input/output response time (a delay time) of a boosting circuit including the boosting transformer T1 and the rectification circuit is 20 μs and which has a startup capability of several hundred volts by switching driving of one pulse as an example. In the present exemplary embodiment, a DC voltage is raised by respective change amounts of 125 V, 200 V, and 300 V for each predetermined period (for each 20 μs) corresponding to the driving frequency. The input/output response time of the boosting circuit becomes dominant. Therefore, it is assumed that there is no delay time other than the above-mentioned delay time. FIGS. 4A to 4C and FIGS. 5A to 5C respectively illustrate a case where the target voltage is 5 kV and a case where the target voltage is 1 kV, to describe an example in which a target voltage is variably set in a width range.

The case where the target voltage is 5 kV will be described with reference to FIGS. 4A to 4C. FIGS. 4A and 4B illustrate examples of an output waveform at the time of startup of a conventional high-voltage generation apparatus in which a rising curve of an output voltage is slowly switched during the startup. In the conventional high-voltage generation apparatus, a rise in an output voltage is slowed by detecting a second reference voltage lower than a target voltage. A transient area serving as a high-speed startup period T1 after the startup is referred to as a first transient area, and a transient area serving as a constant voltage control waiting period T2 where the startup is slow is referred to as a second transient area. In the conventional high-voltage generation apparatus illustrated in FIGS. 4A and 4B, the output voltage is detected at the second reference voltage lower than the target voltage. Therefore, the output voltage that can be controlled at the time point is output after a lapse of 20 μs. Even if driving of the boosting transformer T1 can be stopped the instant that the output voltage is detected, an overshoot occurs after a lapse of 20 μs in the high-voltage generation apparatus in which the output unit is raised by several hundred volts with one pulse. This will be described below in a specific example.

FIG. 4A illustrates an example of an output waveform of a high-voltage generation apparatus in which a second reference voltage is set to 90% of a target voltage and which is boosted by 125 V per one-pulse driving in a first transient area. Since the target voltage is 5 kV, an output voltage is detected by the second reference voltage 4.5 kV that is 90% of the target voltage, to enter a second transient area. However, pulse-driven power has already been applied 20 μs before the output voltage enters the second transient area. Therefore, the output voltage is raised to 4.625 kV, and enters the second transient area after it exceeds 4.625 kV. The output voltage converges to the target voltage 5 kV without any great overshoot because it enters the second transient area at 4.625 kV.

On the other hand, FIG. 4B illustrates an example of an output waveform of a high-voltage generation apparatus in which a second reference voltage is set to 90% of a target voltage and which is boosted by 300 V per one-pulse driving in a first transient area. Since the target voltage is 5 kV, an output voltage is detected by the second reference voltage 4.5 kV that is 90% of the target voltage, to enter a second transient area. However, pulse-driven power has already been applied 20 μs before the output voltage enters the second transient area. Therefore, the output voltage is raised to 4.8 kV, and enters the second transient area after it exceeds 4.8 kV. Since the output voltage enters the second transient area at 4.8 kV, a margin for an overshoot of 5 kV or more is smaller than that illustrated in FIG. 4A. However, the output voltage converges to the target voltage 5 kV without any great overshoot.

When the target voltage is 5 kV, therefore, the output voltage converges to the target voltage 5 kV without any great overshoot even if the high-voltage generation apparatus is boosted by 125 V per one-pulse driving or boosted by 300 V per one-pulse driving by being further speeded up.

If a target voltage is low, and a boosting capability per pulse is high (e.g., the high-voltage generation apparatus is boosted by 300 V per one-pulse driving to a target voltage of 1 kV), as illustrated in FIG. 5B, an overshoot occurs. A case where the target voltage is low, and a boosting capability is slightly high (e.g., the high-voltage generation apparatus is boosted by 125 V per one-pulse driving to a target voltage of 1 kV) will be first described with reference to FIG. 5A.

FIG. 5A illustrates an example of an output waveform of a high-voltage generation apparatus in which a second reference voltage is set to 90% of a target voltage and which is boosted by 125 V per one-pulse driving in a first transient area. Since the target voltage is 1 kV, an output voltage is detected by the second reference voltage 0.9 kV that is 90% of the target voltage, to enter a second transient area. However, pulse-driven power has already been applied 20 μs before the output voltage enters the second transient area. Therefore, the output voltage is raised to 1 kV, and enters the second transient area. Since the output voltage enters the second transient area at 1 kV, there is no margin for an overshoot (a margin voltage A illustrated in FIG. 5A) when the output voltage exceeds 1 kV after the second reference voltage is detected. However, the output voltage converges at the target voltage 1 kV without any great overshoot.

On the other hand, FIG. 5B illustrates an example of an output waveform of a high-voltage generation apparatus in which a second reference voltage is set to 90% of a target voltage and which is boosted by 300 V per one-pulse driving at the time of startup. Since the target voltage is 1 kV, an output voltage is detected by the second reference voltage 0.9 kV that is 90% of the target voltage, to enter a second transient area. However, pulse-driven power has already been applied 20 μs before the output voltage enters the second transient area. Therefore, the output voltage is raised to 1.2 kV, and enters the second transient area after it exceeds 1.2 kV. When the output voltage enters the second transient area, therefore, a great overshoot of 200 V has already been generated (an overshoot voltage B illustrated in FIG. 5B). More specifically, when a startup capability of the high-voltage generation apparatus is not so great, there is no problem. If the startup capability of the high-voltage generation apparatus is further increased so that the output voltage is raised to the target voltage only by inputting several pulses to further shorten a startup time, a great overshoot occurs.

On the other hand, FIGS. 4C and 5C illustrate examples of an output waveform of the high-voltage generation apparatus according to the present exemplary embodiment. The high-voltage generation circuit 8 according to the present exemplary embodiment divides a control period (a time domain) into a high-speed startup period T1 (a first transient area) immediately after the start of startup, a constant voltage control waiting period T2 (a second transient area) elapsed before an output voltage reaches a target voltage, and a constant voltage control period T3 (a steady area) elapsed after the output voltage reaches the target voltage. In the first transient area, a PWM signal having an on-duty width set in a register [DUTY_Tr1 setting unit 134] is output, and an output voltage rises at a high slew rate of 300 V per pulse as a first change amount. In the second transient area, a PWM signal having an on-duty width having a value set in a register [DUTY_Tr2 setting unit 135] is output, and an output voltage rises at a relatively low slew rate of 50 V per pulse as a second change amount. When the output voltage reaches the target voltage, the on-duty width of the PWM signal is instantaneously reduced to zero, and a boosting operation of the high-voltage generation circuit 8 is rapidly stopped. When the output voltage reaches the target voltage, the slew rate is as low as 50 V per pulse. Therefore, the maximum overshoot amount occurring immediately after the output voltage reaches the target voltage is reduced to as low as 50 V.

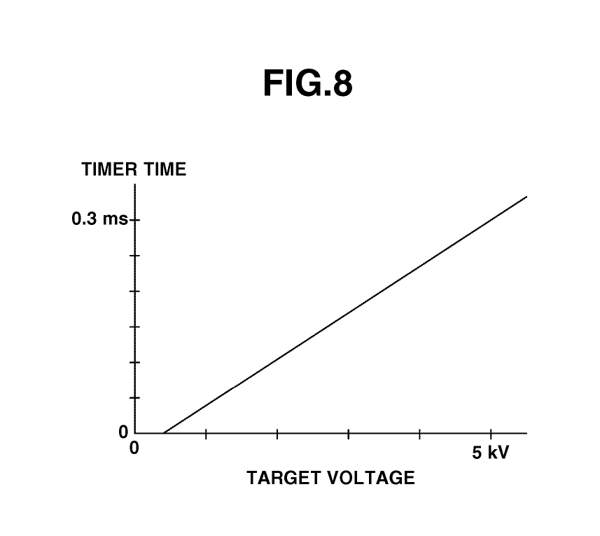

A timer time in the first transient area serving as the high-speed startup period T1 is set to a predetermined value corresponding to the target voltage. In this example, the timer time in the first transient area is set to 0.3 ms and 0.04 ms, respectively, when the target voltage is +5 kV and when the target voltage is +1 kV, as illustrated in FIG. 8. As a result, the first transient area is determined by not feedback control corresponding to detection of the low second reference voltage but the timer time previously variably set. Thus, the overshoot occurring immediately after the output voltage reaches the target voltage is reduced regardless of whether the target voltage is +5 kV or +1 kV, and the output voltage can reach the target voltage in a short time.

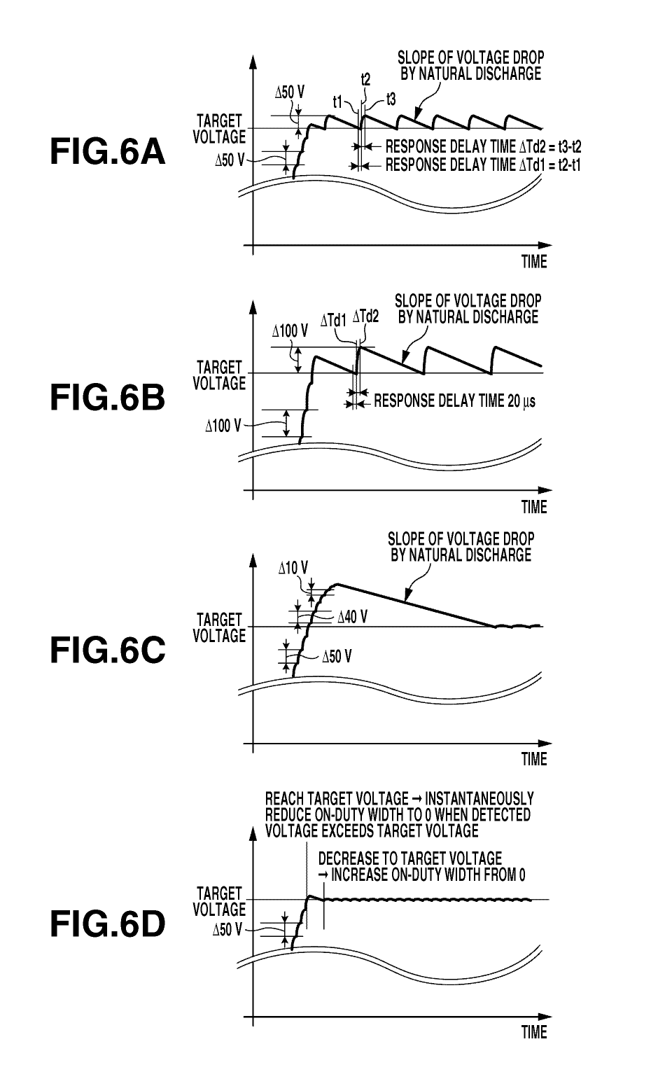

An operation in the constant voltage control period T3 (the steady area) performed immediately after the output voltage reaches the target voltage will be described below with reference to FIGS. 6A to 6D while comparing an example of an output waveform in the present exemplary embodiment with an example of a conventional waveform. FIG. 6D illustrates an example of the output waveform in the present exemplary embodiment. In order to increase a startup time, an on-duty width of a PWM signal immediately after the start of startup is required to be increased to make a response faster. However, when the response is made faster, in a constant voltage control operation, an output voltage easily rises and falls with respect to a target voltage used as a boundary, to repeat an overshoot. This is illustrated in FIG. 6A. The output voltage is raised by 50 V per pulse input after it enters a second transient area. When the output voltage reaches the target voltage, switching is instantaneously turned off. After switching is instantaneously turned off, an electric charge charged in a capacitive load is naturally discharged so that the output voltage falls. More specifically, even if switching of the high-voltage generation circuit 8 is instantaneously turned off, the output voltage does not fall at a natural discharge rate or more. When the output voltage falls to the target voltage, the high-voltage generation circuit 8 starts switching again. Such control that the output voltage rises again by pulse input when switching is started, then reaches the target voltage, and falls when switching is turned off again is repeated. Even if the number of pulses input until switching is turned off is one, however, the one pulse has already been input when the output voltage reaches the target voltage. Therefore, a small voltage vibration (also referred to as a ripple or a hunting) at a voltage corresponding to the one pulse, 50 V in this example, occurs.

FIG. 6B illustrates an example of an output waveform generated when an output voltage is raised by 100 V per one-pulse input after it enters a second transient area. An overshoot occurs by a similar phenomenon to that illustrated in FIG. 6A. However, an overshoot amount is 100 V, which is two times that illustrated in FIG. 6A. A slew rate at which an overshot voltage falls to a target voltage is determined at a time constant for natural discharge by a load capacitance and a resistance. Therefore, the overshoot is repeated with a period that is two times that illustrated in FIG. 6A.

In a high-voltage generation apparatus discussed in Japanese Patent Application Laid-Open No. 9-93920, in a maintenance charging area controlled to maintain a target voltage, an output voltage is slightly increased and decreased by slightly increasing and decreasing an input voltage to a PWM circuit to reduce a voltage vibration of the target voltage. However, at the time of transition from a slow charging area to the maintenance charging area, the input voltage is only slightly decreased. Therefore, an overshoot at a time point where the output voltage reaches the target voltage is easily increased, as illustrated in FIG. 6C.

On the other hand, in an output waveform of the high-voltage generation apparatus according to the present exemplary embodiment illustrated in FIG. 6D, when a detected voltage exceeds a target voltage, an on-duty width of a PWM signal is instantaneously reduced to zero, and the on-duty width is then increased from zero so that switching is resumed when the output voltage falls below the target voltage again. Therefore, an overshoot occurring immediately after the output voltage reaches the target voltage is made lower than that illustrated in FIG. 6C, and a voltage startup capability in the constant voltage control period T3 is reduced. Therefore, in the present exemplary embodiment illustrated in FIG. 6D, a voltage vibration (a ripple or a hunting) generated in a steady area can be made significantly lower than those illustrated in FIGS. 6A and 6B.

In the present exemplary embodiment, a method for varying the timer time in the first transient area according to the magnitude of the target voltage has been described by an example in which the on-duty width of the PWM signal in the first transient area is constant. On the other hand, a method for variably controlling the on-duty width of the PWM signal may be used, as described below. The method for variably controlling the on-duty width of the PWM signal in the first transient area makes variable control of a timer time easily feasible, and can produce a substantially similar effect to that in the above-mentioned method. An example of an operation in the method for variably controlling the on-duty width of the PWM signal in the first transient area will be described below.

<Example of Operation for Variable Control of on-Duty Width of PWM Signal>

(1) An on-duty width of an initial PWM signal in a first transient area serving as a first period and an on-duty width of a PWM signal at the time of transition to a second transient area serving as a second period subsequent to the first period are respectively set, and the on-duty width is gradually changed in the first transient area. The initial on-duty width in the first transient area and the on-duty width at the time of transition to the second transient area are set to predetermined values independently of a target voltage. In order to vary a timer time in the first transient area according to the magnitude of the target voltage, control to change the on-duty width by a predetermined step amount in the first transient area is performed.

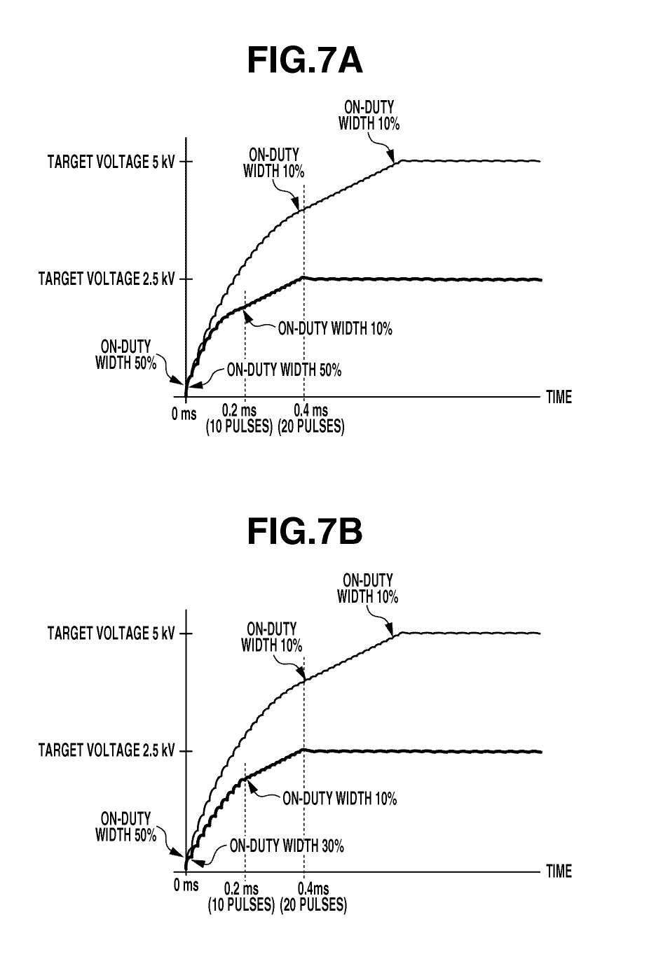

FIG. 7A illustrates an example of a waveform generated when the on-duty width of the initial PWM signal in the first transient area is 50% and the on-duty width of the PWM signal at the time of transition to the second transient area is 10%. FIG. 7A illustrates cases where the target voltage is +5V and +2.5 kV. The on-duty width is decreased by −2% per pulse when the target voltage is +5 kV, and is decreased by −4% per pulse when the target voltage is +2.5 kV. More specifically, the first transient area is variably set according to the magnitude of the target voltage.

(2) An on-duty width of an initial PWM signal in a first transient area and an on-duty width of a PWM signal at the time of transition to a second transient area are respectively set, and the on-duty width is gradually changed in the first transient area. The on-duty width at the time of transition to the second transient area and a step amount (a change amount) in which the on-duty width is gradually changed are set to predetermined values independently of a target voltage. A timer time in the first transient area is varied according to the magnitude of the target voltage. More specifically, the initial on-duty width at the start of startup in the first transient area is variably set.

FIG. 7B illustrates an example of a waveform generated when the on-duty width at the time of transition to the second transient area is 10% and the step amount in which the on-duty width is gradually changed is −2%, for example. FIG. 7B illustrates cases where the target voltage is +5V and +2.5 kV. The on-duty width at the start of startup is set at 50% when the target voltage is +5 kV, and is set at 30% when the target voltage is +1 kV. More specifically, the first transient area is variably set according to the magnitude of the target voltage.

As described above, according to the present exemplary embodiment, the on-duty width of the PWM signal in the first transient area is variably set depending on the target voltage, and the PWM signal is instantaneously output in the high-speed startup period T1. More specifically, the high-voltage generation circuit 8 can be started with a time width at the time of startup, which is varied with a high resolution according to the target voltage, and instantaneously.

Further, when the detected voltage exceeds the target voltage, control is performed so that the detected voltage is maintained at the target voltage by instantaneously reducing the on-duty width of the PWM signal to zero. As a result, even in a high-voltage generation apparatus a startup capability of which is further increased and in which a target voltage is set to a value in a wide range, an output voltage can reach the target voltage without any overshoot and in a short time.

In a startup transient area, output of a voltage is started at a high slew rate in response to a PWM signal having the maximum on-duty width, and the voltage is output at a low slew rate in a steady area where a target voltage is maintained. Thus, even in a high-voltage generation apparatus a startup capability of which is further increased and in which an output voltage reaches a target voltage in a short time, a voltage vibration (a ripple or a hunting) in the steady area can be reduced.

A second exemplary embodiment of the present invention will be described below. A high-voltage generation apparatus according to the second exemplary embodiment previously variably sets a slew rate in a startup transient state according to the magnitude of a target voltage. In the second exemplary embodiment, a voltage variably set while maintaining a relationship of linearity with the target voltage is previously generated, and the generated voltage is applied to a boosting transformer, to wait for startup. Switching driving is started using the variably set voltage for the boosting transformer and a PWM signal having the maximum on-duty width, to perform control so that an output voltage reaches the target voltage at a steep and high slew rate in the transient state.

FIG. 2C is a block diagram schematically illustrating a function of the high-voltage generation apparatus according to the second exemplary embodiment. The high-voltage generation apparatus according to the present exemplary embodiment further includes a block 27 capable of variably setting a slew rate in a startup transient state in a high-speed startup period T1 in addition to the conventional high-voltage generation apparatus illustrated in FIG. 2A. The block 27 has a function of varying a transformer source voltage.

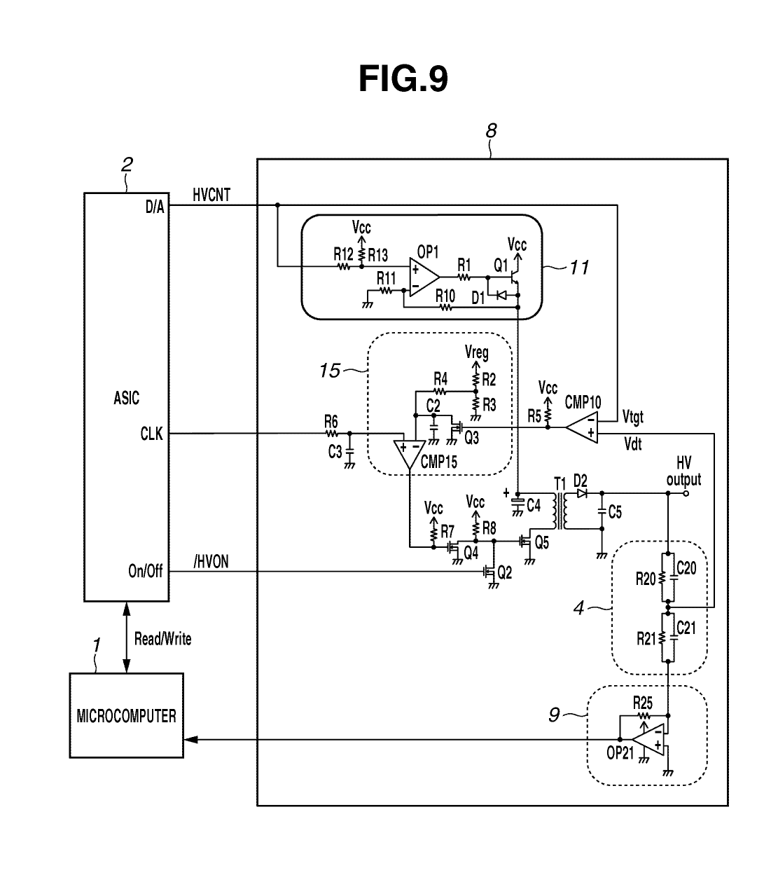

FIG. 9 illustrates the high-voltage generation apparatus according to the second exemplary embodiment. Similar constituent elements and signals to those previously described in the first exemplary embodiment are assigned the same reference numerals and symbols, and hence the description thereof is not repeated. The high-voltage generation apparatus illustrated in FIG. 9 includes a high-voltage generation circuit 8 composed of an analog circuit, and an ASIC 2 functioning as an output control unit for generating a hardware control signal to be output to the high-voltage generation circuit 8, to control output from the high-voltage generation circuit 8. The high-voltage generation apparatus further includes a microcomputer 1 for controlling and setting an output state of a hardware control signal from the ASIC 2. Further, the high-voltage generation circuit 8 includes a boosting transformer T1, a boosting circuit, an output voltage detection circuit 4, a PWM control circuit 15 for generating a PWM signal for driving the boosting transformer T1, a transformer voltage generation circuit 11 for generating a power source voltage connected to the boosting transformer T1, a comparator CMP10, and an output current detection circuit 9.

The microcomputer 1 can control a change in a target voltage of the high-voltage generation apparatus and ON/OFF timing by setting data at predetermined timing for a register (not illustrated) provided in the ASIC 2. The ASIC 2 outputs a high-voltage control signal HVCNT for setting a target voltage of the high-voltage generation circuit 8, an ON/OFF control signal /HVON for setting ON/OFF of the high-voltage generation circuit 8, and a clock signal CLK having a predetermined period used in the high-voltage generation circuit 8 to the exterior.

The high-voltage control signal HVCNT is output to the exterior as an analog signal from a D/A converter provided in the ASIC 2. The high-voltage control signal HVCNT may be output in the form of a PW signal, or may be converted into a DC voltage by a high-order low-pass filter or the like having an improved response characteristic at a frequency of the PWM signal, in which case a similar function can be implemented.

The outline of an operation of the high-voltage generation circuit 8 in the high-voltage generation apparatus illustrated in FIG. 9 will be described below. The transformer voltage generation circuit 11 previously generates a voltage corresponding to the high-voltage control signal HVCNT output from the ASIC 2, and supplies the voltage to the boosting transformer T1 at the time of startup and at a steady time. The boosting transformer T1 is switching-driven in response to the PWM signal output from the PWM control circuit 15. The output voltage detection circuit 4 divides a high voltage output from the boosting transformer T1, to detect a divided voltage Vdt, and the comparator CMP10 performs comparison calculation between the detected divided voltage Vdt and a target voltage Vtgt set in response to the high-voltage control signal HVCNT. An on-duty width of the PWM signal output by the PWM control circuit is feedback-controlled according to a comparison calculation result. The boosting transformer T1 is switching-driven with the on-duty width feedback-controlled.

A capacitor C4 before the start of startup waits for the startup while power corresponding to a voltage generated by the transformer voltage generation circuit 11 is previously charged therein in response to the high-voltage control signal HVCNT. A slew rate at the time of startup is variably set by the previously charged power and the voltage. A voltage output to a load unit HVoutput is raised at a slew rate corresponding to the voltage supplied to the boosting transformer T1.

Details of the operation of the high-voltage generation circuit 8 in the high-voltage generation apparatus illustrated in FIG. 9 will be described below. Operations of the PWM control circuit 15 for variably outputting the PWM signal and the comparator CMP10 will be first described. An output of the comparator CMP10 and a triangular wave signal having a pseudo triangular wave changed from the clock signal CLK via a resistor T6 and a capacitor C3 are connected to the PWM control circuit 15. The PWM control circuit 15 includes a comparator CMP 15, an FET Q3, resistors R2, R3, and R4, and a capacitor C2. The comparator CMP 15 performs comparison calculation between the triangular wave signal connected to a non-inverting input unit and a voltage of an inverting input unit, to variably set an on-duty width of the PWM signal. The lower the voltage of the inverting input unit is, the smaller the on-duty width on the low-level side of the PWM signal to be output is.

The comparator CMP10 performs comparison calculation between the detected divided voltage Vdt and the target voltage Vtgt, to generate a low-level output and turn off the FET Q3 if the detected voltage Vdt is the target voltage Vtgt or less, and generates a high-level output and turn on the FET Q3 if the detected voltage Vdt is the target voltage Vtgt or more. When the FET Q3 is turned on, the inverting input unit in the comparator CMP 15 instantaneously falls to a potential of 0 V. Therefore, an output of the comparator CMP 15 instantaneously enters a high level so that the high-voltage generation circuit 8 is rapidly turned off.

On the other hand, when the FET Q3 is turned off, an electric charge is charged in the capacitor C2 via the resistors R2 to R4 from a power source voltage Vreg. A time constant for the charging is determined by the power source voltage Vreg and values of the resistors R2 to R4 and the capacitor C2. The on-duty width is moderately increased from zero by this time constant. The maximum voltage of the capacitor C2 is obtained by dividing the power supply voltage Vreg via the resistors R2 and R3, and the maximum on-duty width of the PWM signal output by the comparator CMP 15 is set by the maximum voltage of the capacitor C2.

More specifically, the PWM control circuit 15 instantaneously reduces the on-duty width to zero, to rapidly turn off the high-voltage generation circuit 8 when the detected voltage Vdt exceeds the target voltage Vtgt. When the detected voltage Vdt falls below the target voltage Vtgt, a time constant is given to startup, to slowly turn on the high-voltage generation circuit 8. As a result, a voltage vibration (a ripple or a hunting) generated in feedback control for maintaining a constant voltage can be significantly reduced. An output waveform in a steady area in the high-voltage generation apparatus according to the present exemplary embodiment is similar to that illustrated in FIG. 6D in the first exemplary embodiment.

Peripheral circuits of the boosting transformer T1 in the high-voltage generation circuit 8 will be described below. The PWM signal output from the PWM control circuit 15 is input to a gate terminal of an FET Q4. The FET Q4, a power source voltage Vcc, and a resistor R8 drive a gate terminal of a power MOSFET Q5 in response to the PWM signal input to the gate terminal of the FET Q4. The power MOSFET Q5 switching-drives the boosting transformer T1. The boosting transformer T1, which has been switching-driven, outputs a high pulsating voltage. The high pulsating voltage output by the boosting transformer T1 is rectified by a rectifier including a high-voltage diode D2 and a high-voltage capacitor C5 and is changed into a direct voltage, and is output to the load unit HVoutput. The output voltage detection circuit 4 divides the high voltage output to the load unit HVoutput, to detect a divided voltage Vdt. The comparator CMP10 monitors the detected divided voltage Vdt, and compares the divided voltage Vdt with the target voltage Vtgt set in response to the high-voltage control signal HVCNT, to perform feedback control for maintaining the target voltage.

An FET Q2 directly controls the gate terminal of the power MOSFET Q5 in response to the ON/OFF control signal /HVON so that a response delay time can be reduced when the high-voltage generation circuit 8 is turned on and off. If the response delay time may be slightly delayed, the high-voltage generation circuit 8 may be turned on and off by fixing the clock signal CLK output from the ASIC 2 to a high-level output in place of the ON/OFF control signal /HVON and the FET Q2.

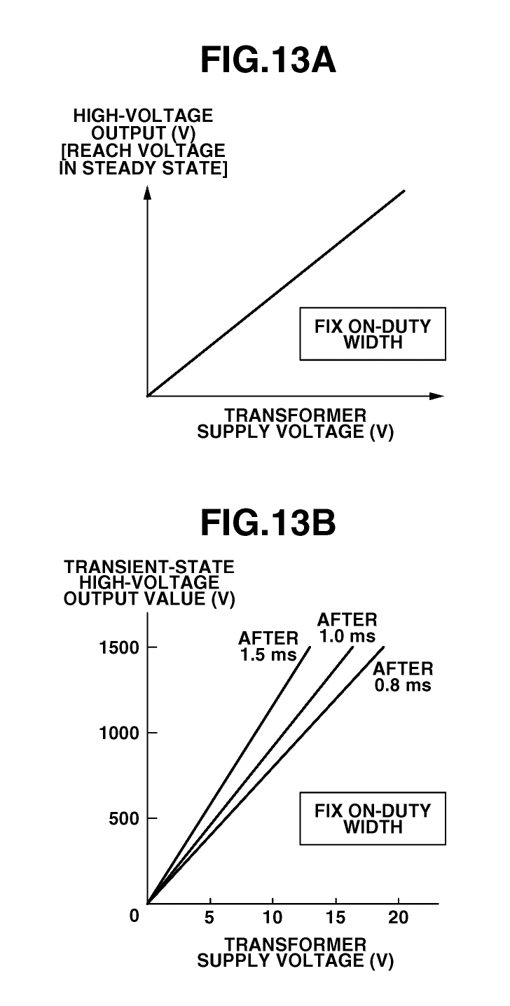

The transformer voltage generation circuit 11 for generating a power source voltage connected to the boosting transformer T1 will be described below. The transformer voltage generation circuit 11 includes an operation amplifier OP1, resistors R1, and R10 to R13, a diode D1, and a transistor Q1. The operation amplifier OP1 current-drives the transistor Q1 to perform feedback control so that an output corresponding to the high-voltage control signal HVCNT input from the ASIC 2 is maintained in response to the high-voltage control signal HVCNT and a voltage varied by non-inversion amplifying a divided voltage of a power source voltage Vcc. An electric charge is charged in the capacitor C4 connected to the boosting transformer T1 by a current amplified by the transistor Q1. The diode D1 constitutes a current path when the operation amplifier OP1 discharges a current from the capacitor C4. The transformer voltage generation circuit 11 generates a voltage for transformer driving having a relationship of linearity in proportion to a voltage corresponding to the high-voltage control signal HVCNT. The high-voltage generation circuit 8 has a property of outputting an output voltage (a reach voltage in a steady area without feedback control) proportional to the power source voltage connected to the boosting transformer T1 when the on-duty width of the PWM signal to be switching-driven is fixed. FIGS. 13A and 13B illustrate the property. In the present exemplary embodiment, feedback control is performed to decrease the on-duty width of the PWM signal, to perform control to maintain the output voltage at the target voltage.

While the PWM control circuit 15 outputs the PWM signal having the maximum on-duty width, and a voltage variably generated in response to the high-voltage control signal HVCNT is applied to the boosting transformer T1 during waiting for startup, it is forcedly turned off by the FET Q2 arranged downstream. If the FET Q2 is turned off, therefore, switching can be instantaneously started in response to the PWM signal having the maximum on-duty width.

An example of an operation for variably setting a slew rate in a startup transient state variably set in the present exemplary embodiment will be described below. An amount of power (a voltage value) charged in the capacitor C4 by the transformer voltage generation circuit 11 is applied when the high-voltage generation circuit 8 is started, and becomes one element for determining a slew rate at the time of rise in an output voltage (one of input driving conditions). Another element for determining the slew rate at the time of rise in an output voltage (one of input driving conditions) is the maximum on-duty width at the start of switching. In the present exemplary embodiment, the maximum on-duty width at the time of startup is a fixed value independently of the target voltage. Therefore, the high-voltage generation circuit 8 has the property that the slew rate at the time of startup is varied according to only an output value of the transformer voltage generation circuit 11. FIG. 13B illustrates a relationship between an on-duty width of a PWM signal and a high output voltage after a lapse of a predetermined time (corresponding to a voltage rising curve or a slew rate in a transient state). As can be seen from FIG. 13B, the output voltage in the transient state attained after a lapse of the same time is directly proportional to the power source voltage connected to the boosting transformer T1.

The high-voltage generation apparatus according to the present exemplary embodiment uses this direct relationship, to variably set the slew rate in the transient state of the output voltage at the power source voltage connected to the boosting transformer T1. The power source voltage connected to the boosting transformer T1 is variably set according to the magnitude of the target voltage. When the high-voltage generation circuit 8 is started, therefore, the slew rate at the time of startup can be variably set with high accuracy and with a high resolution. For example, when the target voltage is low, the slew rate is variably set to decrease so that an overshoot is reduced. On the other hand, when the target voltage is high, the slew rate is variably set to increase so that a startup period is shortened. Further, the high-voltage generation circuit 8 is linearly started up with such an on-duty width that the output voltage reaches the target voltage in an output state where hardware is steeply started up (a state occurring before its time constant reaches a gently inclined curve). When the hardware detects that the output voltage has reached the target voltage, the on-duty width is instantaneously reduced to zero, to turn off a boosting circuit. Thus, an overshoot at the time of the startup can be further reduced.

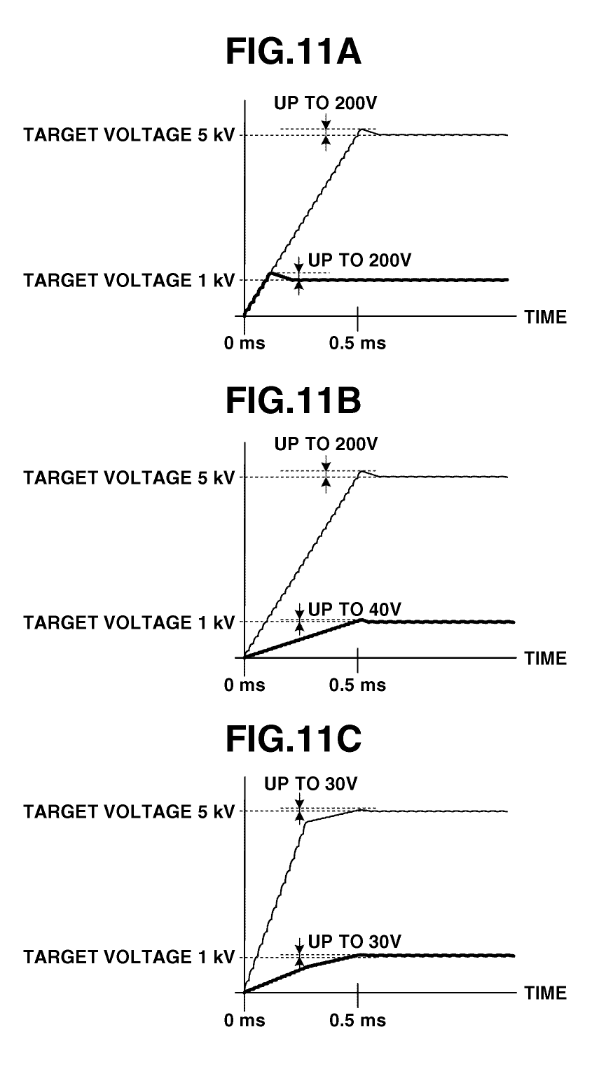

A specific example of an output waveform in the high-voltage generation apparatus according to the present exemplary embodiment will be described below with reference to FIGS. 11A and 11B. FIG. 11A illustrates an example of an output waveform generated when the method according to the present exemplary embodiment is not applied, and FIG. 11B illustrates an example of an output waveform generated when the method according to the present exemplary embodiment is applied. FIG. 11A illustrates an example of an output waveform generated when a slew rate in a startup transient state is constant independently of the magnitude of a target voltage. An output voltage is raised by 200 V per one-pulse driving (20 μs). When the target voltage is +5 kV, the output voltage reaches the target voltage at 0.5 ms. As also described in the first exemplary embodiment, a response delay time occurs in input and output of a boosting circuit. Therefore, at a time point where it is detected that the output voltage has reached the target voltage, power driven 20 μs before the time point has already been applied. More specifically, an overshoot of a maximum of 200 V is generated. 200 V at the time of +5 kV is an overshoot amount that is reduced to as low as approximately 4% of the target voltage. However, the overshoot amount depends on the startup capability of the high-voltage generation circuit 8, i.e., the slew rate in the startup transient state. Therefore, even if the target voltage is +1 kV, an overshoot of a maximum of 200 V occurs. 200 V at the time of +1 kV is an overshoot amount that is 20% of the target voltage.

On the other hand, FIG. 11B illustrates an example of an output waveform in the present exemplary embodiment in which a slew rate in a startup transient state is variably set according to the magnitude of a target voltage. When the target voltage is +5 kV, an overshoot amount is reduced to as low as approximately 4% of the target voltage, like in FIG. 11A. When the target voltage is +1 kV, a voltage supplied to the boosting transformer T1 is previously variably set to a reduced value. Therefore, the slew rate is reduced to a low slew rate at which an output voltage is raised by 40 V per pulse. As a result, the output voltage reaches the target voltage at 0.5 ms, and the overshoot amount is reduced by a maximum of 40 V. More specifically, the overshoot amount is 40 V when the target voltage is +1 kV. Therefore, the overshoot amount is approximately 4% of the target voltage, and can be made significantly lower than that illustrated in FIG. 11A.

As described above, according to the present exemplary embodiment, the voltage variably set depending on the output voltage is previously generated, and the startup is waited for with the generated voltage applied. Thus, the high-voltage generation circuit 8 can be started at a slew rate at the time of startup, which is varied with a high resolution according to the output voltage, and instantaneously. Further, when the detected voltage exceeds the target voltage, control to instantaneously reduce the on-duty width to zero to maintain the detected voltage at the target voltage is performed. Even if the startup capability of the high-voltage generation apparatus is increased and the target voltage is set to a value in a wide range, the overshoot is reduced, and the output voltage can reach the target voltage in a short time.

In the startup transient area, the output of the voltage is started at a high slew rate in response to the PWM signal having the maximum on-duty width, and the voltage is then output at a low slew rate in the steady area where the output voltage is maintained at the target voltage. Thus, even a high-voltage generation apparatus a startup capability of which is further increased and in which an output voltage reaches a target voltage in a short time can reduce a voltage vibration (a ripple or a hunting) in a steady area.

A third exemplary embodiment of the present invention will be described below. A high-voltage generation apparatus according to the third exemplary embodiment previously variably sets a slew rate in a startup transient state according to the magnitude of a target voltage. In the third exemplary embodiment, a PWM signal having an on-duty width variably set while maintaining a relationship of linearity with the target voltage is generated. Switching is started using the PWM signal having the on-duty width variably set with the start of startup so that an output voltage reaches the target voltage at a steep slew rate in a transient state. FIG. 2C is a block diagram schematically illustrating a principal function of the high-voltage generation apparatus according to the present exemplary embodiment, which is similar to that in the second exemplary embodiment. The high-voltage generation apparatus according to the present exemplary embodiment further includes a block 27 capable of variably setting a slew rate in a startup transient state in addition to the conventional high-voltage generation apparatus illustrated in FIG. 2A. The on-duty width of the PWM signal is varied in the block 27.

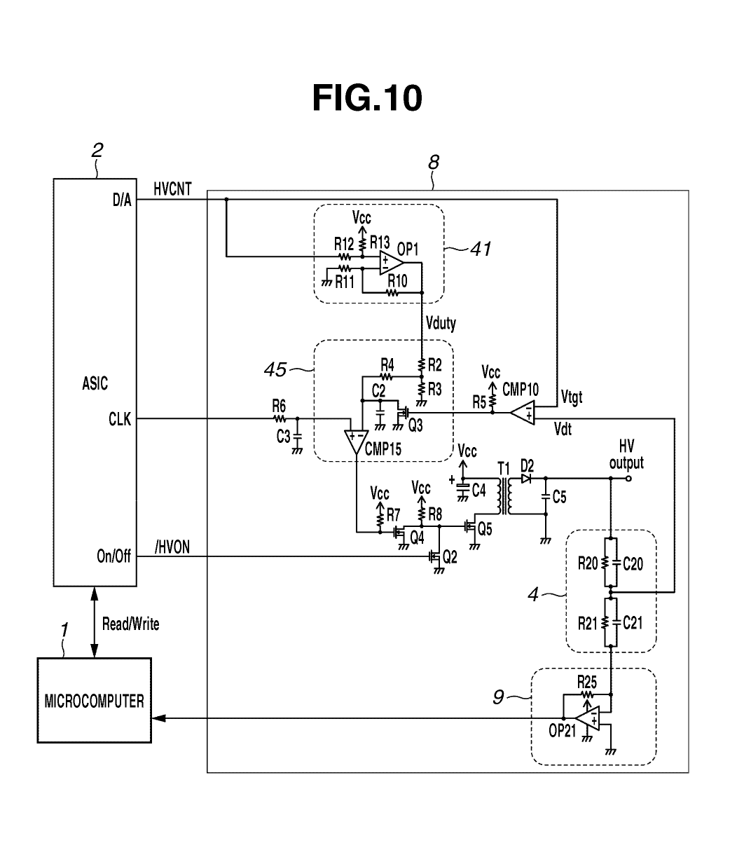

FIG. 10 illustrates the high-voltage generation apparatus according to the third exemplary embodiment. In the present exemplary embodiment, an output of a maximum DUTY setting circuit 41 is connected in place of the power source voltage Vreg connected in the PWM control circuit 15 in the second exemplary embodiment, and a power source voltage Vcc having a fixed value is connected in place of the transformer voltage generation circuit 11 connected to the boosting transformer T1 in the first exemplary embodiment. The maximum DUTY setting circuit 41 is formed by deleting a current amplification circuit portion from the transformer voltage generation circuit 11 described in the second exemplary embodiment, and at low cost. Similar constituent elements and signals to those already described in the first and second exemplary embodiments are assigned the same reference numerals and symbols, and hence the description thereof is not repeated.

The outline of an operation of a high-voltage generation circuit 8 in the high-voltage generation apparatus illustrated in FIG. 10 will be first described. The maximum DUTY setting unit 41 generates a variable voltage Vduty, described below, in response to a high-voltage control signal HVCNT output from an ASIC 2, and supplies the generated variable voltage Vduty to a PWM control circuit 45 at the time of startup and at a steady time. The PWM control circuit 45 generates a PWM signal having an on-duty width corresponding to the supplied variable voltage Vduty, and a boosting transformer T1 is switching-driven in response to the PWM signal. An output voltage detection circuit 4 divides a high output voltage from the boosting transformer T1, to detect a divided voltage Vdt, and a comparator CMP10 performs comparison calculation between the detected divided voltage Vdt and a target voltage Vtgt set in response to the high-voltage control signal HVCNT. The on-duty width of the PWM signal output by the PWM control circuit 45 is feedback-controlled according to a comparison calculation result. The boosting transformer T1 is switching-driven with the on-duty width feedback-controlled. More specifically, the maximum DUTY setting circuit 41 variably sets the maximum on-duty width, and performs feedback control so that the output voltage becomes the target voltage Vtgt in a range of the on-duty width.

Details of the operation of the high-voltage generation circuit 8 in the high-voltage generation apparatus illustrated in FIG. 10 will be then described below. Peripheral circuits of the boosting transformer T1 in the high-voltage generation circuit 8 are similar to those in the second exemplary embodiment, and hence the description thereof is not repeated. The maximum DUTY setting circuit 41 and the PWM control circuit 45 will be described.

The maximum DUTY setting circuit 41 includes an operation amplifier OP1 and resistors R10 to R13, and non-inversion amplifies the high-voltage control signal HVCNT and a divided voltage of the power source voltage Vcc and outputs the non-inversion amplified signal and voltage to the PWM control circuit 45. The maximum DUTY setting circuit 41 generates the reference voltage Vduty for setting the maximum on-duty width while maintaining a relationship of linearity in proportion to an output voltage corresponding to the high-voltage control signal HVCNT, and outputs the reference voltage Vduty to the PWM control circuit 45.

The DC voltage Vduty generated by the maximum DUTY setting circuit 41 is connected in place of the power source voltage Vreg in the PWM control circuit 15 described in the second exemplary embodiment to the PWM control circuit 45. When an FET Q3 is turned off, an electric charge is charged in a capacitor C2 via resistors R2 to R4 from the DC voltage Vduty generated by the maximum DUTY setting circuit 41. A time constant for the charging is determined by the direct-current voltage Vduty and values of the resistors R2 to R4 and the capacitor C2. The on-duty width is moderately increased from zero by this time constant.

More specifically, the PWM control circuit 45 generates the PWM signal having the maximum on-duty width that is varied according to the magnitude of the input voltage Vduty while instantaneously reducing the on-duty width to zero, to instantaneously turn off the high-voltage generation circuit 8 when the detected voltage Vdt exceeds the target voltage Vtgt, like in the first and second exemplary embodiments. When the detected voltage Vdt falls below the target voltage Vtgt, a time constant is given to startup, to slowly turn on the high-voltage generation circuit 8. As a result, a voltage vibration (a ripple or a hunting) can be significantly suppressed. An output waveform in a steady area in the high-voltage generation apparatus according to the present exemplary embodiment is similar to that illustrated in FIG. 6D in the first exemplary embodiment.

A voltage of the capacitor C2 is kept at a voltage obtained by dividing the DC voltage Vduty via the resistors R2 and R3 at a steady time. The maximum on-duty width of a PWM signal output by a comparator CMP 15 is set by the voltage at the steady time. The DC voltage Vduty generated by the maximum DUTY setting circuit 41 is variably set at a voltage proportional to the high-voltage control signal HVCNT. More specifically, the maximum on-duty width of the PWM signal is variably set in proportion to the high-voltage control signal HVCNT.

While the PWM control circuit 45 outputs the PWM signal having the maximum on-duty width during waiting for startup, it is forcedly turned off by the FET Q2 arranged downstream. If the FET Q2 is turned off, therefore, switching can be instantaneously started in response to the PWM signal having the maximum on-duty width.

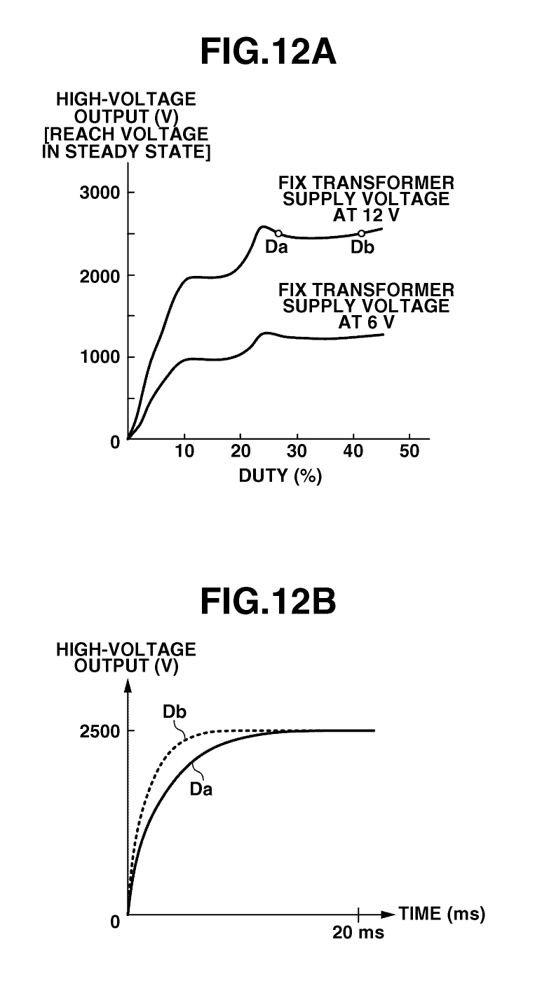

A relationship between a slew rate in a startup transient state variably set in the present exemplary embodiment and a duty-width will be described below with reference to FIGS. 12A and 12B, FIGS. 13A and 13B, and FIG. 14.

FIG. 12A illustrates a relationship between an on-duty width of a PWM signal for switching-driving the high-voltage generation circuit 8 and an output voltage (a reach voltage in a steady state without feedback control) as characteristic curves measured using a boosting circuit for steeply raising a voltage of an output unit. A transformer source voltage and an output voltage have a proportional relationship, as described in FIG. 13A in the second exemplary embodiment. Therefore, the characteristic curves indicate that an output voltage generated when an input voltage is 6V is half an output voltage generated when it is 12 V. However, the on-duty width of the PWM signal for performing switching driving and the output voltage do not have a proportional relationship but greatly vary.

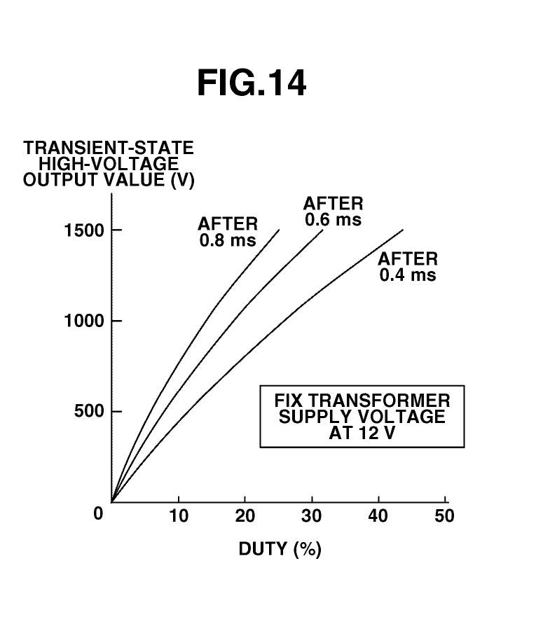

In the characteristic curve obtained when the input voltage is 12 V, both output voltages (reach voltages in a steady area without feedback control) at a point Da having an on-duty width in the vicinity of 27% and a point Db having an on-duty width in the vicinity of 43% are approximately 2500 V even if duty widths at the points of the PWM signal for performing switching driving differ from each other. However, the slew rates at the time of startup at the points greatly differ from each other, as illustrated in FIG. 12B. Even if both reach values at which the output voltages at the points are saturated without feedback control are 2500 V, the output voltage at the point Db having the larger on-duty width rises faster. FIG. 14 illustrates a relationship between an on-duty width in the transient state of an output voltage and a high output voltage after a lapse of a predetermined time (corresponding to a voltage rising curve or a slew rate in the transient state) as measured characteristic curves. The output voltage in the transient state attained after a lapse of the same time is substantially directly proportional to the duty width.

The high-voltage generation apparatus according to the present exemplary embodiment uses the property that an on-duty width and an output voltage in a transient state are proportional to each other, to variably set the slew rate in the transient state of the output voltage. The maximum on-duty width at the start of startup is previously set to a value corresponding to a target voltage, to start the high-voltage generation circuit 8. More specifically, a load voltage is raised while the slew rate is variably set according to the target voltage. For example, when the target voltage is low, the slew rate is variably set to decrease so that an overshoot is reduced. On the other hand, when the target voltage is high, the slew rate is variably set to increase so that a startup period is shortened. In that case, the high-voltage generation unit 8 is linearly started up with such a time width that the output voltage reaches the target voltage at a slew rate at which hardware is steeply started up (a state occurring before its time constant reaches a gently inclined curve). When the hardware then detects that the output voltage has reached the target voltage, the on-duty width is instantaneously reduced to zero, to rapidly turn off the high-voltage generation circuit 8.

As a result, even a high-voltage generation circuit 8 in which a slew rate is high when an output voltage rises, and an output voltage (a reach voltage in a steady area without feedback control) does not have a proportional relationship with a duty width does not perform control dependent on a relationship between the on-duty width and the output voltage (the reach voltage in the steady area without feedback control) in the high-voltage generation apparatus according to the present exemplary embodiment. Therefore, reductions in accuracy and stability of control occurring in the conventional high-voltage generation circuit can be avoided. The output waveform in the high-voltage generation apparatus according to the present exemplary embodiment is similar to that illustrated in FIG. 11B in the second exemplary embodiment.

As described above, according to the present exemplary embodiment, the PWM signal having the on-duty width variably set depending on the output voltage is generated, and the high-voltage generation apparatus is instantaneously started up in response to the PWM signal having the on-duty width variably set. Thus, the high-voltage generation circuit 8 can be started at a slew rate at the time of startup, which is varied with a high resolution depending on the output voltage, and instantaneously. Further, when the detected voltage exceeds the target voltage, the on-duty width of the PWM signal is instantaneously reduced to zero, to control maintenance of the target voltage. Even when the startup capability of the high-voltage generation apparatus is increased and the target voltage is set to a value in a wide range, an overshoot can be reduced, and the output voltage can reach the target voltage in a short time. A boosting circuit in which an on-duty width of a PWM signal and an output voltage (a reach voltage in a steady state) do not have a proportional relationship enables highly accurate and stable voltage control.

Output of a voltage is started in response to a PWM signal having the maximum on-duty width in a startup transient area while the voltage is output by giving a gentle time constant to startup to increase the on-duty width in a steady area where the subsequent target voltage is maintained. Even a high-voltage generation apparatus a startup capability of which is increased and in which an output voltage reaches a target voltage in a short time can reduce a voltage vibration (a ripple or a hunting) in a steady area throughout the area.

The high-voltage generation apparatuses according to the first to third exemplary embodiments, described above, can be applied to an electrophotographic image forming apparatus. An example of an application of the high-voltage generation apparatus will be described by taking a laser beam printer as an example of the electrophotographic image forming apparatus.

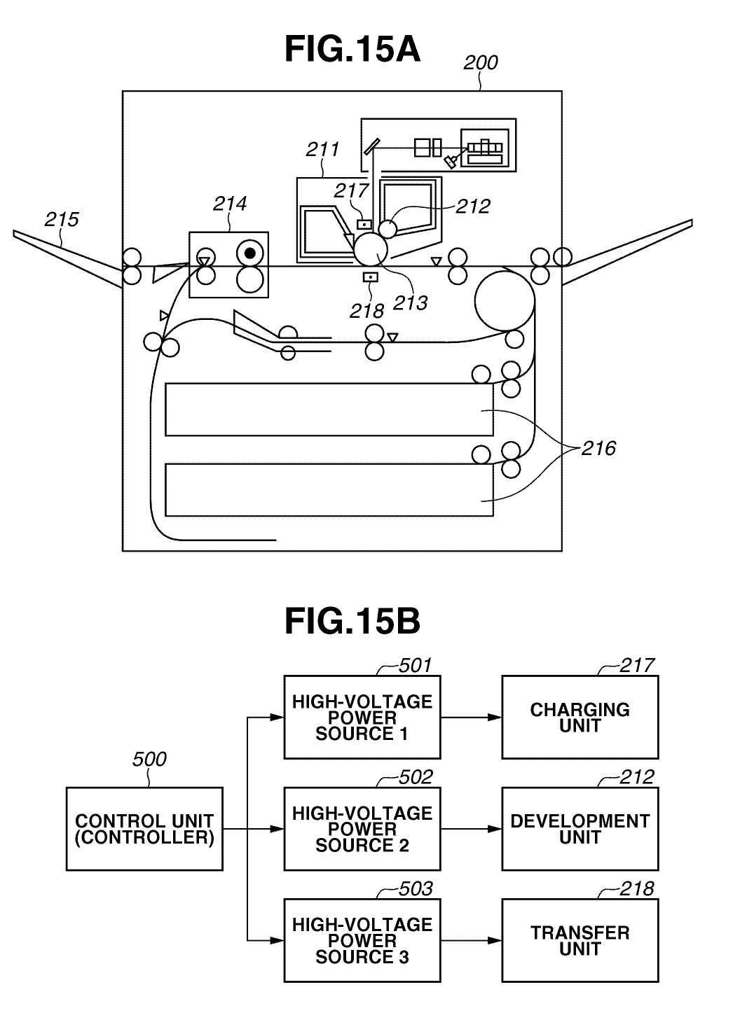

The high-voltage generation apparatus described in the above-mentioned exemplary embodiment is applicable as a high-voltage power source for applying a high voltage to an image forming unit in an electrophotographic printer. FIG. 15A illustrates a schematic configuration of a laser beam printer as an example of the electrophotographic printer. A laser beam printer 200 includes a photosensitive drum 211 serving as an image bearing member on which a latent image is formed, a charging unit 217 for uniformly charging the photosensitive drum 211, and a development unit 212 for developing the latent image formed on the photosensitive drum 211 with toner. A transfer unit 218 transfers a toner image developed on the photosensitive drum 211 onto a sheet (not illustrated) serving as a recording material supplied from a cassette 216, a fixing device 214 fixes the toner image that has been transferred on the sheet, and discharges the sheet to a tray 215. The photosensitive drum 211, the charging unit 217, the development unit 212, and the transfer unit 218 constitute an image forming unit.

FIG. 15B illustrates a configuration in which high voltages output from a plurality of high-voltage power sources 501 to 503 provided in the laser beam printer 200 (the high-voltage generation apparatuses according to any one of the first to third exemplary embodiments) are respectively output to the charging unit 217, the development unit 212, and the transfer unit 218. The first high-voltage power source 501 outputs a high voltage to the charging unit 217, the second high-voltage power source 502 outputs the high voltage to the development unit 212, and the third high-voltage power source 503 outputs the high voltage to the transfer unit 218. The high voltages output from the high-voltage power sources 501 to 503 are respectively controlled to be voltages required in response to a control signal output from a controller 500 serving as a control unit. When the high voltage is output to the charging unit 217, for example, the above-mentioned output current detection circuit 9 detects a current flowing through the charging unit 217, to adjust the output so that the detected current has a predetermined value. When the high voltage is output to the transfer unit 218, the output current detection circuit 9 detects a current flowing through the transfer unit 218, to adjust the output so that the detected current has a predetermined value. When the high voltage is output to the development unit 212, the above-mentioned output voltage detection circuit 4 detects a voltage, to adjust the output so that the detected voltage has a predetermined value. Thus, the high-voltage power source is applicable to apply a high voltage for image formation. More specifically, when the above-mentioned ATVC control is executed, while image formation is being continuously performed on a plurality of recording materials, between the recording materials (also referred to as between sheets), a high-voltage startup operation by the transfer unit 218 described in the first to third exemplary embodiments is applicable. Thus, an operation for applying a high voltage as in the ATVC control can be performed at high speed.

As described above, if the high-voltage power sources described in the first to third exemplary embodiments are applied as high-voltage power sources for an electrophotographic printer, the speed of the image forming apparatus can be increased, and the FPOT can be shortened.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-172292 filed Jul. 30, 2010, which is hereby incorporated by reference herein in its entirety.

What is claimed is:

1. A high-voltage generation apparatus comprising:
a transformer;
a switching unit configured to drive the transformer;
a generation unit configured to generate a driving signal for driving the switching unit;
a rectification unit configured to rectify an output voltage from the transformer to output a direct-current voltage;
a detection unit configured to detect the direct-current voltage;
a setting unit configured to set a target voltage of the direct-current voltage;
a feedback control unit configured to control the driving signal according to the detected direct-current voltage and the set target voltage; and
an output control unit configured to raise the direct-current voltage by a change amount corresponding to the target voltage without performing a feedback control by the feedback control unit in a transient-state period elapsed since the output of the direct-current voltage is started until the direct-current voltage reaches the target voltage.

2. The high-voltage generation apparatus according to claim 1, wherein the output control unit variably controls the change amount.

3. The high-voltage generation apparatus according to claim 2, wherein a power source voltage supplied to the transformer is switched to switch the change amount.

4. The high-voltage generation apparatus according to claim 1, wherein the transient-state period includes a first period during which the direct-current voltage is raised by a first change amount and a second period, subsequent to the first period, during which the direct-current voltage is raised by a second change amount smaller than the first change amount.

5. The high-voltage generation apparatus according to claim 4, wherein the first change amount is variably set for each predetermined period in the first period.

6. The high-voltage generation apparatus according to claim 4, wherein the driving signal is a PWM signal, and
wherein an on-duty width of the PWM signal is varied to variably set the change amount.

7. The high-voltage generation apparatus according to claim 6, wherein the on-duty width is instantaneously reduced to zero when the detected voltage exceeds the target voltage, and is then gradually increased when the detected voltage becomes lower than the target voltage.

8. The high-voltage generation apparatus according to claim 6, wherein the on-duty width is set to a maximum time width when the output of the direct-current voltage is started.

9. An image forming apparatus comprising:
an image forming unit configured to form an image on a recording material; and
a high-voltage power source configured to apply a high voltage to the image forming unit,
wherein the high-voltage power source includes
a transformer,
a switching unit configured to drive the transformer,
a generation unit configured to generate a driving signal for driving the switching unit,
a rectification unit configured to rectify an output voltage from the transformer to output a direct-current voltage,
a detection unit configured to detect the direct-current voltage,
a setting unit configured to set a target voltage of the direct-current voltage,
a feedback control unit configured to control the driving signal according to the detected direct-current voltage and the set target voltage, and
an output control unit configured to raise the direct-current voltage by a change amount corresponding to the target voltage without performing a feedback control by the feedback control unit in a transient-state period elapsed since the output of the direct-current voltage is started until the direct-current voltage reaches the target voltage.

10. The image forming apparatus according to claim 9, wherein the image forming unit includes a charging unit configured to charge an image bearing member, or a transfer unit configured to transfer a toner image formed on the image bearing member.

11. A high-voltage generation apparatus comprising:
an output unit configured to output a voltage;
a detection unit configured to detect the output voltage;
a setting unit configured to set a target value of the output voltage;
a feedback control unit configured to control driving of the voltage output unit according to the detected voltage and the set target value; and
an output control unit configured to control to raise the output voltage by a change amount corresponding to the target value without performing the control by the feedback control unit in a transient-state period elapsed since the output of the voltage from the voltage output unit is started until the voltage reaches the target value.

12. The high-voltage generation apparatus according to claim 11, wherein the change amount is variably controlled.

13. The high-voltage generation apparatus according to claim 12, wherein a power source voltage supplied to the voltage output unit is switched to switch the change amount.

14. The high-voltage generation apparatus according to claim 11, wherein the transient-state period includes a first period during which the voltage is raised by a first change amount and a second period, subsequent to the first period, during which the voltage is raised by a second change amount smaller than the first change amount.

15. The high-voltage generation apparatus according to claim 14, wherein the first change amount is variably set for each predetermined period in the first period.

16. The high-voltage generation apparatus according to claim 14, wherein a driving signal is a PWM signal, and
wherein an on-duty width of the PWM signal is varied to variably set the change amount.

17. The high-voltage generation apparatus according to claim 16, wherein the on-duty width is instantaneously reduced to zero when the detected voltage exceeds the target value, and is then gradually increased when the voltage becomes lower than the target value.

18. The high voltage generation apparatus according to claim 16, wherein the on-duty width is set to a maximum time width when the output of the voltage from the voltage output unit is started.

19. An image forming apparatus comprising:
an image forming unit configured to form an image on a recording material; and
a high-voltage power source configured to apply a high voltage to the forming unit,
wherein the high-voltage power source includes
an output unit configured to output a voltage,
a detection unit configured to detect the output voltage,
a setting unit configured to set a target value of the output voltage,
a feedback control unit configured to control driving of the voltage output unit according to the detected voltage and the set target value, and
an output control unit configured to control to raise the output voltage by a change amount corresponding to the target value without performing the control by the feedback control unit in a transient-state period elapsed since the output of the voltage from the voltage output unit is started until the voltage reaches the target value.

20. The image forming apparatus according to claim 19, wherein the image forming unit includes a charging unit configured to charge an image bearing member, or a transfer unit configured to transfer a toner image formed on the image bearing member.
